(19) United States
(12) Patent Application Publication
(10) Pub. No.: US 2007/0044435 A1
(43) Pub. Date: Mar. 1, 2007

(54) Bottle pest entry prevention method and apparatus

(76) Inventor: Robert C. Sotile, Rochester, NY (US)

Correspondence Address: SHLESINGER & FITZSIMMONS, 183 EAST MAIN STREET, SUITE 1323, ROCHESTER, NY, 14604, US

(21) Appl. No.: 11/211,008

(22) Filed: Aug. 24, 2005

(51) Int. Cl. B67B 3/00

(52) U.S. Cl. 53/420; 53/485

(57) ABSTRACT

A new use for an ice cream cone holder, the holder comprising a cylindrical portion with an open end and a closed end and a disc portion about the open end. The new use is preventing pest entry into bottles by placing a closed end of the ice cream cone holder over an open bottle so that the holder engages at least one of a side wall, a top, and a pour spout mounted in a top of a bottle. Using the holder in such a fashion is surprisingly effective, efficient of user resources, and easy to use.

### CROSS-REFERENCE TO RELATED APPLICATIONS

This application is related to U.S. Design Patents Nos. D382,085 and D391,036, which are incorporated by reference in their entireties.

### BACKGROUND AND SUMMARY

Many establishments that serve beverages, including liquor, wine, and the like, suffer from a recurrent problem of pests entering or trying to enter open bottles, taps, and other containers and dispensers of their beverages. Examples of such pests include fruit flies, drain flies, phorid flies, ants, roaches, sphaerocerid flies, and other insects, and can include small mammals, such as mice. When these pests become trapped in the bottles, they often die and contaminate the beverages in the bottles, resulting in the waste of the contents of the bottles. “Bottle” is used inclusively to indicate bottles, taps, and other containers and dispensers.

In addition to contamination by dying in bottles and the like, these pests can introduce disease-causing bacteria and sometimes lay their eggs on the containers. Larvae emerge from the eggs to feed near the surface of the fermenting material for several days and might not be noticed because of their small size. Ingesting fruit fly larvae can cause intestinal discomfort and diarrhea even apart from what bacteria they might carry would do to a person. While fruit flies frequent fresh fruits and vegetables, they are drawn to fermenting materials and visit rotting fruits and vegetables, drains, garbage, and damp organic materials. They breed in drains, sewers, septic tanks, and sewerage-contaminated soil. Ants visiting bottles in a bar can track through many other substances and thus introduce contaminants. Roaches are notoriously dirty creatures and carry many undesirable contaminants. The flies lay eggs near or on top of fermenting materials, such as beverages, decaying fruits and vegetables, garbage, and slime in drains. Thus, there is a strong incentive to prevent pest entry into bottles.

Currently, one method bartenders and others use to prevent pest entry into bottles is to use plastic wrap to cover the bottles. This does prevent most pests from entering the containers, but plastic wrap is difficult to place on such bottles. For example, one way to apply plastic wrap is to take a large roll of wrap, start at an end of a row of bottles, and draw wrap about each bottle until the end of the row is reached. Alternatively, individual pieces can be applied to respective bottles. Unfortunately, accidental breakage of bottles can occur while applying the wrap. Additionally, the wrap has a tendency to come off the bottles spontaneously, and slows bartenders down when they have to remove the wrap and/or replace the wrap.

An alternative method for inhibiting pest entry is to cover bottles with cloths, such as tablecloths, bar cloths, towels, and the like. These are far less effective at preventing pest entry, and some establishments use soiled cloths, which can introduce bacteria, viruses, and other contaminants themselves. Thus, there is a need for a simple, easy, quick, and economical method for preventing entry of pests into beverage bottles.

Embodiments contemplate covering open bottles of liquor, wine, and the like with a simple apparatus of the type disclosed in U.S. Design Patent No. D391,036. While the apparatus of the '036 patent was designed to hold ice cream cones and prevent drippings from soiling a user's clothing and the like, such apparatus is well-suited to this new use by placing the apparatus over the end of an open bottle, tap, or other container. Surprisingly, this method results in near total elimination of the pest problem discussed above. In addition, this method provides bartenders and others with an easy to apply, easy to remove, and easy to replace option for pest entry prevention that also is very quick to use. This is due in large part to snug engagement of the side wall of the apparatus with the side wall of the bottle, particularly in the conical form of the apparatus. Additionally, particularly in the substantially cylindrical form of the apparatus, the closed end of the apparatus can rest on an open bottle top or pour spout, blocking pest entry. Further, with use the external surface of the apparatus can become sticky from spilled contents and the like, and can act as a pest trap.

### BRIEF DESCRIPTION OF THE DRAWINGS

FIG. 1 is a schematic elevational view of the apparatus of embodiments in which the cone receptor is a substantially cylindrical portion.

FIG. 2 is a schematic view of the apparatus of embodiments from the closed end of its cylindrical portion.

FIG. 3 is a schematic view of the apparatus of embodiments placed over an open bottle, such as a liquor bottle, according to embodiments.

FIG. 4 is a schematic flow diagram of the method of embodiments.

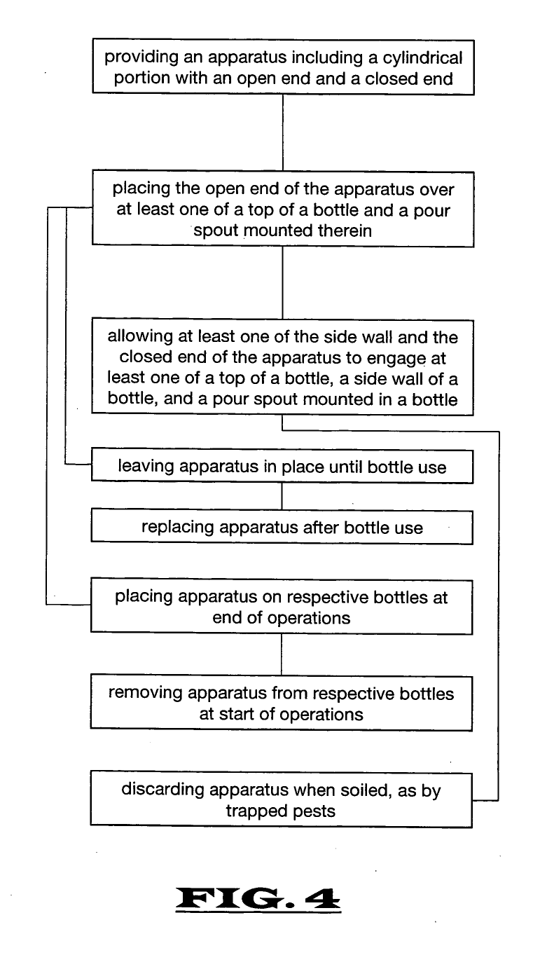

FIG. 5 is a schematic elevational view of the apparatus of embodiments in which the cone receptor is a substantially conical portion.

FIG. 6 is a schematic view of the apparatus of embodiments from the closed end of its conical portion.

FIG. 7 is a schematic view of the apparatus of embodiments placed over an open bottle, such as a liquor bottle, according to embodiments.

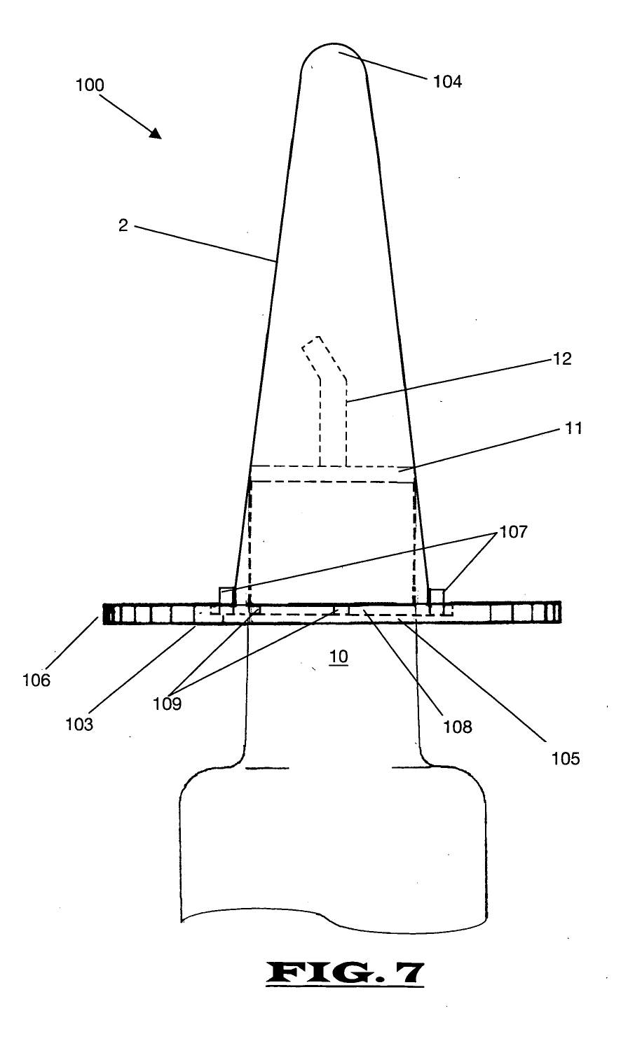

FIG. 8 is a schematic flow diagram of the method of embodiments.

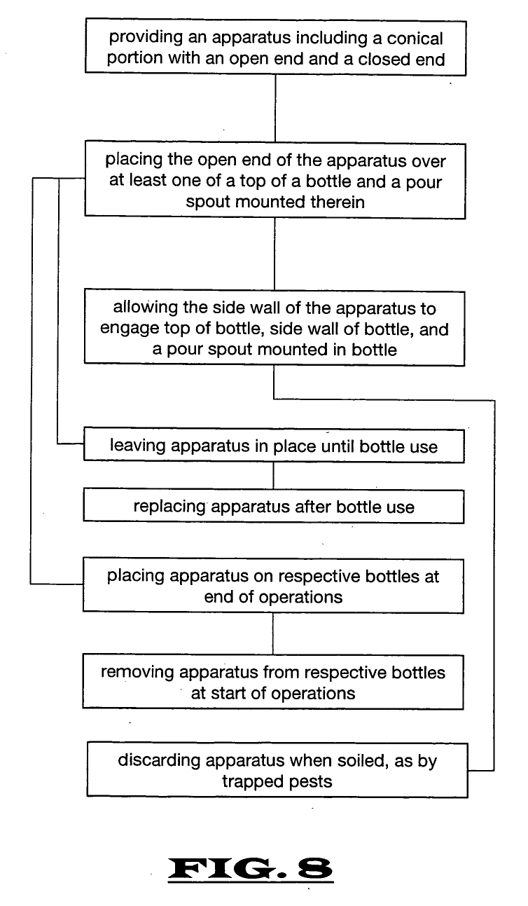

### DESCRIPTION

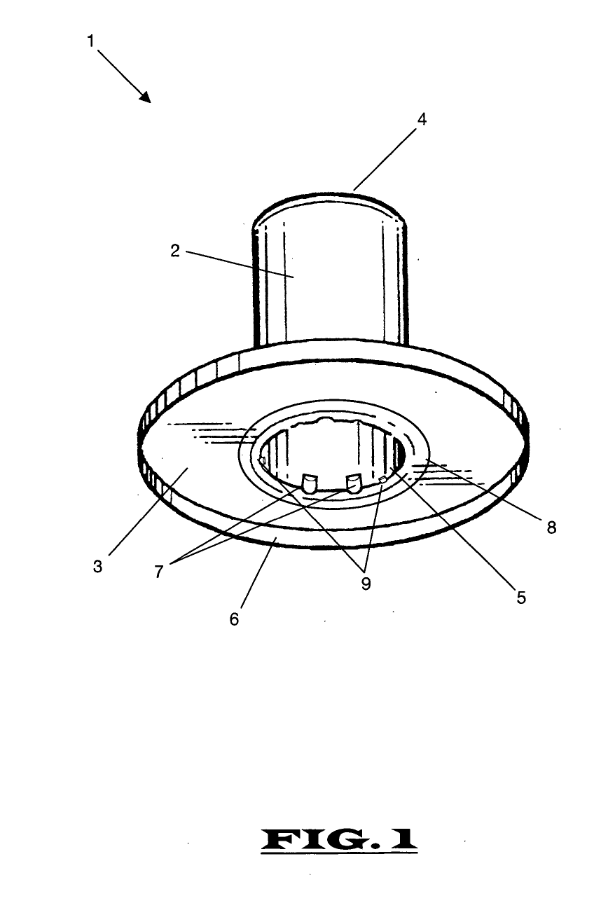

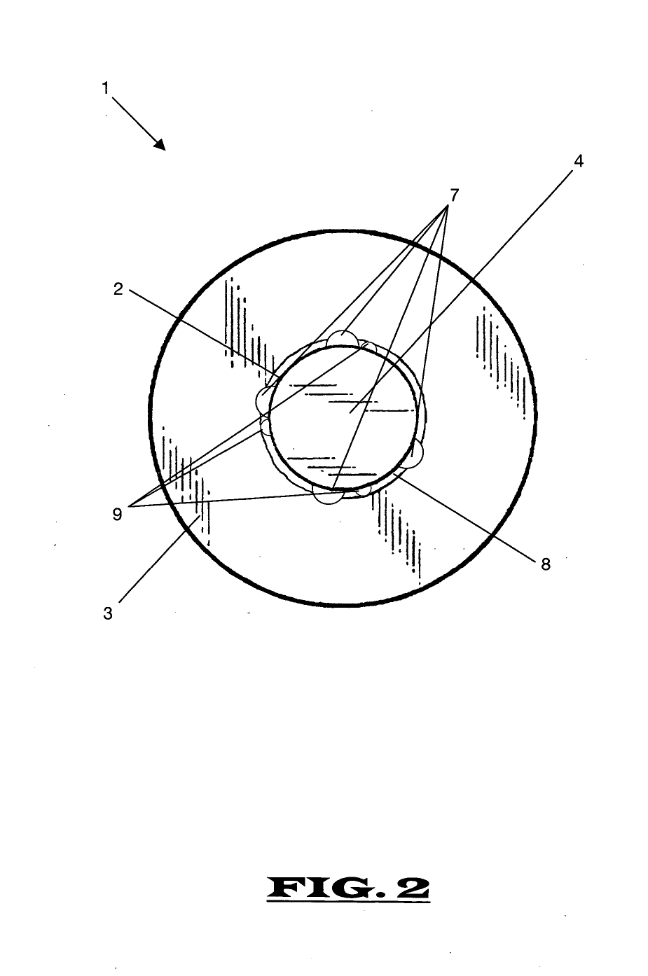

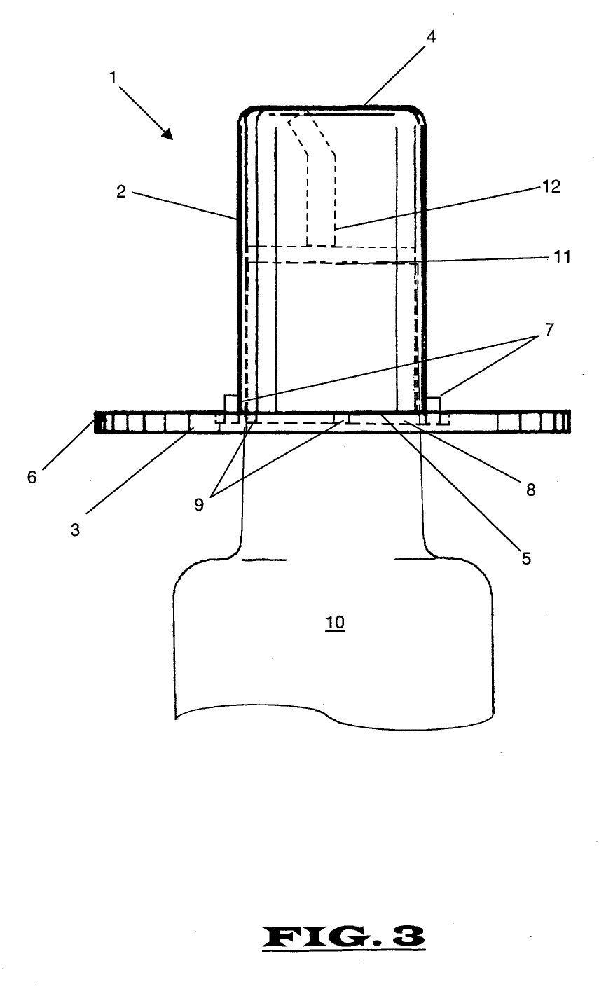

Embodiments contemplate the use of apparatus such as that disclosed in U.S. Design Patent D391,036. With reference to FIGS. 1-3, an embodiment of the apparatus 1 is an ice cream cone holder comprising a conical portion 2 and a disc portion 3. The conical portion 2 is closed on one end 4 and open on the other 5, and the side walls have a steep slope relative to the disc portion 3 such that the conical portion appears to be substantially cylindrical. Further, the closed end 4 is parallel to a surface of the disc portion 3, is substantially flat, and is substantially circular.

The disc portion 3 is formed about the open end 5 of the cylindrical portion 2 and includes a rim 6 about its periphery to prevent spillage of ice cream drippings captured by the disc portion 3. About the open end 5, a plurality of de-nesting notches 7 are formed, preferably in varying patterns from one holder to the next, to prevent stacked apparatus from sticking together by vacuum formation, static electricity, and the like, when one on an end of a stack is removed. A lip 8 is formed in the disc portion 3 around the open end 5 to help keep drippings in the disc portion 3. However, for extreme drippings capture, it is preferable to have drippings enter the cylindrical portion rather than spill over the rim 6, so at least one drainage notch 9 is included in the lip 8 to allow drippings to enter the cylindrical portion 2 when the disc portion 3 is full. Preferably, the apparatus 1 is a single piece of material, such as plastic or paperboard. An effective conical portion can have a length of from about 1 to about 1.5 times the diameter of the open end and a closed end of substantially flat, circular form with a diameter of from about 0.75 to about 0.9 times the diameter of the open end.

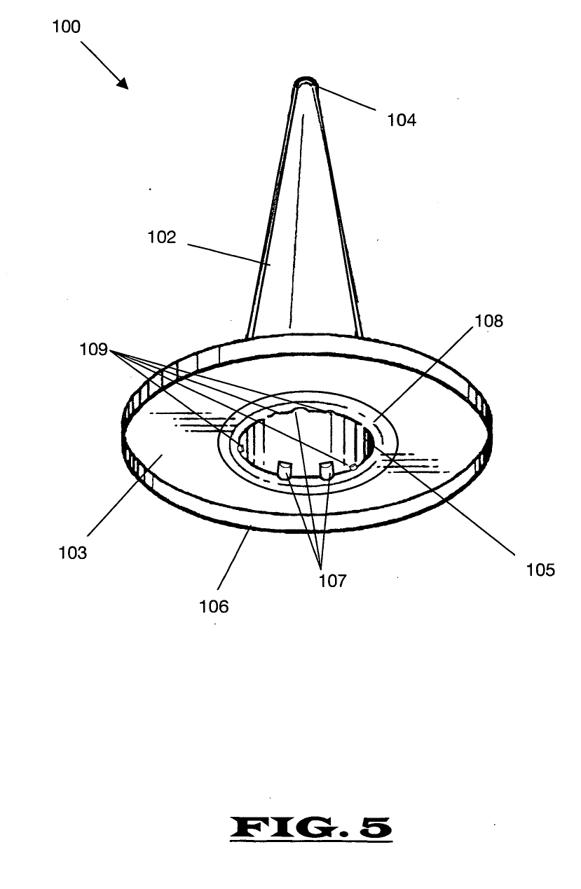

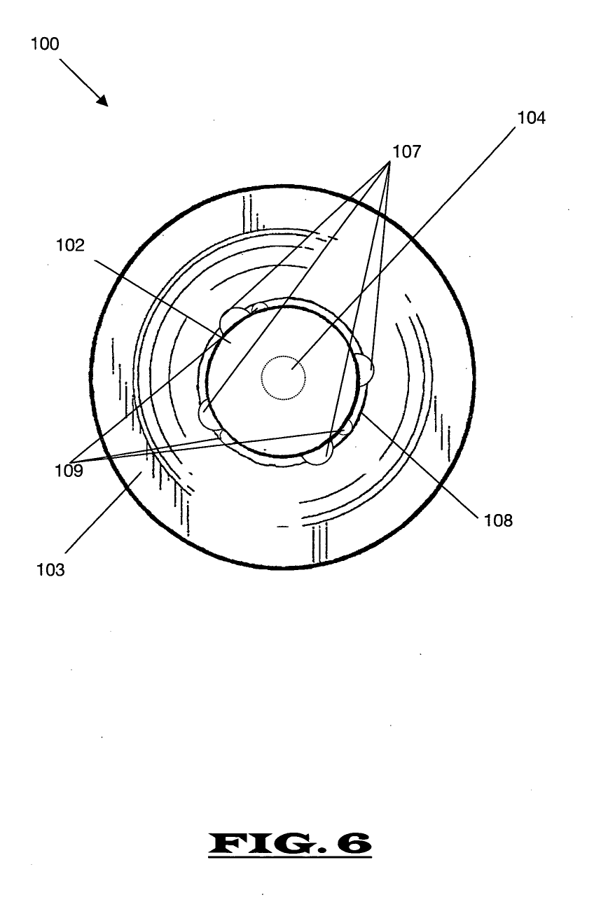

FIGS. 5-6 show another embodiment of the apparatus 100, also an ice cream cone holder, comprising a substantially conical portion 102 and a disc portion 103. Here, the conical nature of the conical portion 102 is much more pronounced and noticeable than in the apparatus of FIGS. 1-3. The conical portion 102 is closed at one end 104 and open at the other 105, the closed end 104 being substantially hemispherical. The disc portion 103 is formed about the open end 105 of the conical portion 102 and includes a rim 106 about its periphery to prevent spillage of ice cream drippings captured by the disc portion 103. About the open end 105, a plurality of de-nesting notches 107 are formed, preferably in varying patterns from one holder to the next, to prevent stacked apparatus 100 from sticking together by vacuum formation, static electricity, and the like, when one on an end of a stack is removed. A lip 108 is preferably formed in the disc portion 103 around the open end 105 to help keep drippings in the disc portion 103, thus avoiding soaking the ice cream cone contained therein. However, for extreme drippings capture, it is preferable to have drippings enter the cylindrical portion rather than spill over the rim 106, so at least one drainage notch 109 is included in the lip 108 to allow drippings to enter the cylindrical portion 102 when the disc portion 103 is full. Preferably, the apparatus 100 is a single piece of material, such as plastic or paperboard. An effective conical portion can have a length of from about 2 to about 3 times the diameter of the open end and can have a substantially hemispherical closed end with a diameter of from about 0.25 to about 0.5 times the diameter of the open end.

The apparatus was designed to be used with the open end 5, 105 facing upward such that an ice cream cone can be inserted into the cylindrical or conical portion 2, 102. In such a configuration, drippings from the ice cream on the ice cream cone would fall onto the disc portion 3, 103, preventing drips onto floors, clothes, shoes, skin, and other surfaces upon which drips would be undesirable.

During a visit to an establishment, the current practice of wrapping bottle tops, taps, and other containers in plastic wrap to prevent pest entry was observed. “Bottle” is used inclusively herein to indicate bottles, taps, and other containers and dispensers. An authority of the establishment complained of the difficulty and inefficiency the current method entailed. The inventor conceived of the method of inverting the ice cream cone holder and placing it atop the bottles, which in experimentation proved to be extremely effective, as well as easy and efficient. In addition, the holder can be used to cover pour spouts and the like commonly used in bars and other establishments that enable easy, substantially drip free pouring of bottle contents. Still further, liquor leavings on the external surface of the conical portion 102 and cylindrical portion 2 can become sticky, acting as a trap for pests. When pests become trapped on the apparatus 1, 100, the apparatus can be discarded and new apparatus can be employed.

Embodiments thus contemplate a method of providing an apparatus 1, 100 with a conical portion 1, 102, placing an open end 5, 105 of the conical portion 2, 102 over the top 11 of a bottle 10, and moving the apparatus 1, 100 into engagement with at least one of the side wall of the bottle, the top of the bottle, and a pour spout mounted in the bottle, if present. The method of embodiments can further comprise placing apparatus over bottles at close of operations of an establishment and removing the apparatus when operations resume. Embodiments contemplate leaving apparatus in place except when a bottle is actually used, at which time the apparatus is removed, the bottle is used, and the apparatus is replaced. Additional embodiments comprise discarding an apparatus when it has trapped pests on its surface.

Through experimentation, it is clear that the more pronounced conical portion 102 is preferred over the substantially cylindrical portion 2 of FIGS. 1-3 in most deployments. Further, the de-nesting notches 7, 107, 8, 108, and drainage notches 109, as well as the rim 106, do not figure prominently in the pest preventative engagement between the apparatus 1, 100 and the bottle 10 or pour spout 12. Even the disc portion 3, 103 could be removed, though the disc portion 3, 103 aids in handling the apparatus 1, 100. Further, the best prevention occurs when the side wall of the conical portion is somewhat flexible, allowing formation of a seal between the side walls of the conical portion and the bottle.

It will be appreciated that various of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art which are also intended to be encompassed by the following claims.

What is claimed is:

1. A bottle pest entry prevention method comprising:
providing an apparatus including a conical portion with an open end and a closed end;
placing the open end of the apparatus over at least one of a top of a bottle and a pour spout mounted therein; and
allowing the apparatus to engage at least one of a side wall of a bottle, a top of a bottle, and a pour spout mounted therein.

2. The method of claim 1 wherein providing an apparatus includes providing the conical portion with a length of from about 2 to about 3 times a diameter of the open end.

3. The method of claim 1 wherein providing an apparatus includes providing the conical portion with a length of from about 1 to about 1.5 times a diameter of the open end.

4. The method of claim 1 wherein providing an apparatus includes providing the closed end with substantially hemispherical form and with a diameter of from about 0.25 to about 0.5 times a diameter of the open end.

5. The method of claim 1 wherein providing an apparatus includes providing the closed end with substantially flat, circular form and with a diameter of from about 0.75 to about 0.9 times a diameter of the open end.

6. The method of claim 1 wherein allowing the apparatus to engage comprises sliding the open end along the bottle until a side wall of the apparatus engages a side wall of the bottle and securing the apparatus by forming an interference fit with the engagement.

7. The method of claim 1 wherein a plurality of bottles are to be protected, the method further comprising placing respective apparatus on each bottle to be protected and leaving the apparatus in place until a bottle is to be used.

8. The method of claim 1 wherein a plurality of bottles are to be protected, the method further comprising placing respective apparatus on each bottle to be protected at an end of operations of an establishment in which the bottles are located and removing the apparatus at a resumption of operations of the establishment.

9. A new use for an ice cream cone holder, the holder comprising:
a conical portion;
an open end of the conical portion;
a closed end of the conical portion;
the new use comprising a bottle pest entry prevention method including:
arranging the ice cream cone holder so that the open end of the conical portion faces an open end of a bottle;
sliding the conical portion of the ice cream cone holder over the end of a bottle; and
allowing the cylindrical portion engage at least one of a side wall of the bottle, a top of the bottle, and a pour spout mounted therein.

10. The method of claim 9 wherein allowing the apparatus to engage comprises sliding the open end along the bottle until a side wall of the apparatus engages a side wall of the bottle and securing the apparatus by forming an interference fit with the engagement.

11. The method of claim 9 wherein a plurality of bottles are to be protected, the method further comprising placing respective apparatus on each bottle to be protected.

12. The method of claim 11 further comprising leaving the apparatus in place until a bottle is to be used.

13. The method of claim 11 wherein placing respective apparatus on each bottle further comprises placing the apparatus at an end of operations of an establishment in which the bottles are located and removing the apparatus at a resumption of operations of the establishment.

14. The method of claim 9 further comprising reusing the apparatus until pests become trapped on the apparatus.

15. A method comprising preventing pest entry into bottles by arranging an open end of an ice cream cone holder to face an open end of a bottle and engaging at least one of a side wall of a bottle, a top of a bottle, and a pour spout mounted therein with the ice cream cone holder.

16. The method of claim 15 wherein providing an apparatus includes:
providing the conical portion with a length of from about 1 to about 3 times a diameter of the open end; and
providing the closed end with substantially hemispherical form and with a diameter of from about 0.25 to about 0.5 times a diameter of the open end.

17. The method of claim 15 wherein allowing the apparatus to engage comprises sliding the open end along the bottle until a side wall of the apparatus engages a side wall of the bottle and securing the apparatus by forming an interference fit with the engagement.

18. The method of claim 15 wherein a plurality of bottles are to be protected, the method further comprising placing respective apparatus on each bottle to be protected, leaving the apparatus in place until a bottle is to be used, and replacing the apparatus after use of the bottle.

19. The method of claim 18 wherein a plurality of bottles are to be protected, the method further comprising placing respective apparatus on each bottle at an end of operations of an establishment in which the bottles are located and removing the apparatus at a resumption of operations of the establishment.

20. The method of claim 15 further comprising reusing the apparatus until pests become trapped on the apparatus.
